(19) United States
(12) Patent Application Publication
(10) Pub. No.: US 2014/0373158 A1
(43) Pub. Date: Dec. 18, 2014

(54) DETECTING SECURITY VULNERABILITIES ON COMPUTING DEVICES

(71) Applicant: International Business Machines Corporation, Armonk, NY (US)

(72) Inventors: Roee Hay, Herzliya (IL); Daniel Kalman, Tel-Aviv (IL); Roi Saltzman, Rishon Le Zion (IL); Omer Tripp, Har-Adar (IL)

(73) Assignee: INTERNATIONAL BUSINESS MACHINES CORPORATION, Armonk, NY (US)

(21) Appl. No.: 13/920,540

(22) Filed: Jun. 18, 2013

(51) Int. Cl. G06F 21/57

(52) U.S. Cl. CPC G06F 21/577
USPC 726/25

(57) ABSTRACT

Identifying security vulnerabilities on computing devices by gathering information about a first software application with which a computing device is configured, selecting, using any of the information, an attack specification from a set of predefined attack specifications, attacking the first software application on the computing device with an attack that is in accordance with the selected attack specification, identifying a post-attack condition associated with the first software application, determining whether the post-attack condition is consistent with a predefined security vulnerability, and performing a predefined action associated with the predefined security vulnerability responsive to determining that the post-attack condition is consistent with the predefined security vulnerability, where the gathering, selecting, attacking, identifying, determining, and performing are performed by a second software application during execution of the second software application on the computing device.

### FIELD OF THE INVENTION

The invention relates in general to computer-based tools for detecting security vulnerabilities.

### BACKGROUND OF THE INVENTION

Inter-process communication channels provided by computer operating systems such as iOS™ and Android™ have been shown to expose computer users to security risks such as broadcast theft, activity hijacking, service hijacking, broadcast injection, and unauthorized launch of activities and services. For example, the Intent-based mechanism of Android™ for moving data between processes, including applications or components within applications, have been shown to expose users to risks due to improper authentication of incoming Intents or unsafe Intents that transmit sensitive information.

### SUMMARY OF THE INVENTION

In one aspect of the invention a method is provided for identifying security vulnerabilities on computing devices, by gathering information about a first software application with which a computing device is configured, selecting, using any of the information, an attack specification from a set of predefined attack specifications, attacking the first software application on the computing device with an attack that is in accordance with the selected attack specification, identifying a post-attack condition associated with the first software application, determining whether the post-attack condition is consistent with a predefined security vulnerability, and performing a predefined action associated with the predefined security vulnerability responsive to determining that the post-attack condition is consistent with the predefined security vulnerability, where the gathering, selecting, attacking, identifying, determining, and performing are performed by a second software application during execution of the second software application on the computing device.

In other aspects of the invention systems and computer program products embodying the invention are provided.

### BRIEF DESCRIPTION OF THE DRAWINGS

The invention will be understood and appreciated more fully from the following detailed description taken in conjunction with the appended drawings in which:

FIG. 1 is a simplified conceptual illustration of a system for detecting security vulnerabilities on a computing device, constructed and operative in accordance with an embodiment of the invention;

FIG. 2 is a simplified flowchart illustration of an exemplary method of operation of the system of FIG. 1, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

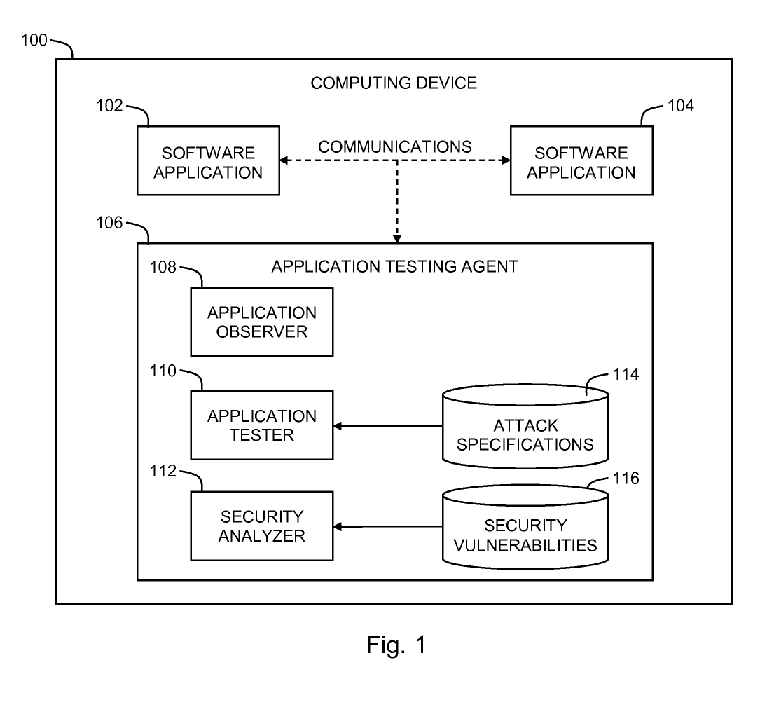

Reference is now made to FIG. 1, which is a simplified conceptual illustration of a system for detecting security vulnerabilities on a computing device, constructed and operative in accordance with an embodiment of the invention. In the system of FIG. 1, a computing device 100 is shown, which may be a mobile telephone, a personal digital assistant, or any other type of computing device capable of hosting an operating system that itself hosts and supports communications between software applications, such as the Android™ operating system, commercially available from Google Corporation, Mountain View, Calif., or the iOS™ operating system, commercially available from Apple Incorporated, Cupertino, Calif. The term “software application” as used herein may refer to any of software applications configured with computing device 100, components within such software applications, and components of the operating system itself. Two such software applications 102 and 104 are shown during their execution on computing device 100.

An application testing agent 106 is also shown during its execution on computing device 100, where application testing agent 106 preferably includes an application observer 108, an application tester 110, and a security analyzer 112. Application observer 108 is preferably configured to gather information about software applications configured with computing device 100. For example, where computing device 100 hosts the Android™ operating system, application observer 108 may access “manifest” data associated with the software applications configured with computing device 100 to identify the types of communications that the software applications can accept, where such manifest data are also configured with computing device 100. Application observer 108 may additionally or alternatively be configured to detect communications between software applications on computing device 100, such as communications between software applications 102 and 104. Application observer 108 may additionally or alternatively be configured to interact with any of the software applications configured with computing device 100, where application observer 108 gathers information regarding the behavior of software applications with which application observer 108 interacts, and/or regarding the behavior of software applications with which application observer 108 does not interact.

Application tester 110 is preferably configured to select, using any of the information gathered by application observer 108, one or more attack specifications from a set 114 of predefined attack specifications. For example, if application observer 108 observes that a software application receives SQL requests, application tester 110 may select an SQL injection attack specification. Application tester 110 is also preferably configured to adapt a selected attack specification, such as by configuring a test payload for use with a selected attack specification and adapting a selected attack specification using any of the information gathered by application observer 108. For example, if application observer 108 observes that a software application receives only integer values for a given type of input, application tester 110 may configure a test payload with only integer values. Application tester 110 then preferably attacks any of the software applications on computing device 110, or one or more specific software applications such as may be preselected for testing, with one or more attacks in accordance with any of the selected attack specifications and using any known attack technique, such as using black-box or glass-box testing techniques.

Security analyzer 112 is preferably configured to identify one or more post-attack conditions associated with any of the software applications on computing device 110, and/or associated specifically with any of the software applications attacked by application tester 110. Such post-attack conditions may be determined using any known technique, such as using black-box or glass-box testing techniques. For example, security analyzer 112 may identify such post-attack conditions by comparing the behavior of a software application after an attack with the behavior of the software application that was observed by application observer 108 before the attack and identifying differences in such behavior. Security analyzer 112 is also preferably configured to determine whether the post-attack condition is consistent with one or more predefined security vulnerabilities, where such predefined security vulnerabilities may be stored in a set 116 of predefined security vulnerabilities. For example, security analyzer 112 may identify a cross-application scripting (XAS) vulnerability where application tester 110 injects JavaScript™ to a software application on computing device 300, such that if the attacks succeed, the software application is redirected to an HTTP service that records that the attack succeeded, where this information is also available to security analyzer 112. Security analyzer 112 is also preferably configured to perform one or more predefined actions associated with any identified predefined security vulnerability after determining that a post-attack condition is consistent with a predefined security vulnerability. For example, security analyzer 112 may provide a notification to a user of computing device 100, such as via a speaker or a display of computing device 100, describing the security vulnerability, and/or terminating or otherwise quarantining any software application with which the security vulnerability is associated.

Any of the elements shown in FIG. 1 are preferably implemented by, are embodied within, or are otherwise accessible to, computing device 100, such as by implementing any of the elements in computer hardware and/or in computer software embodied in a non-transitory, computer-readable medium in accordance with conventional techniques.

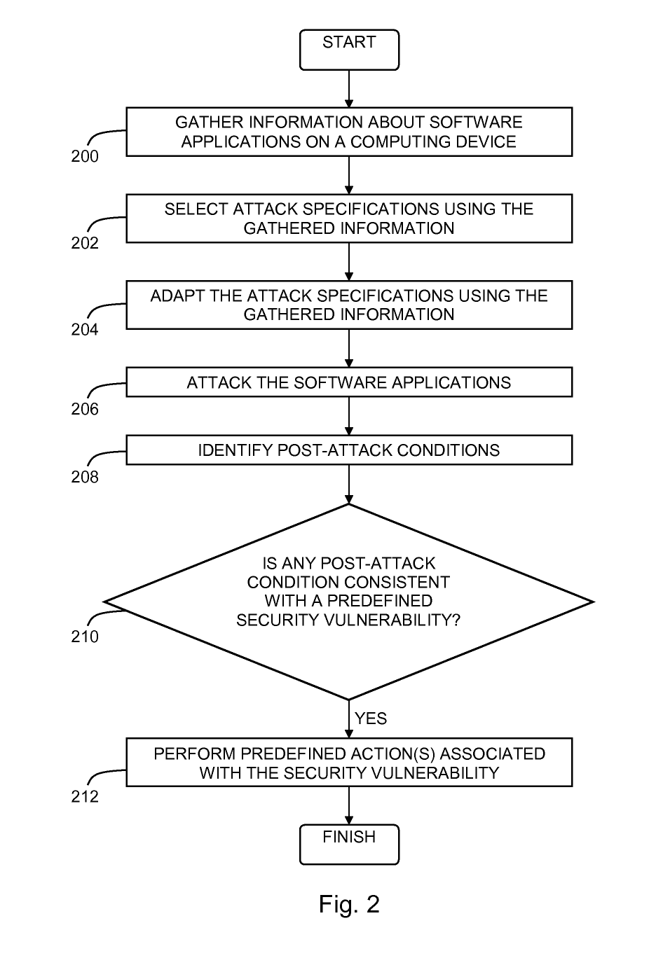

Reference is now made to FIG. 2, which is a simplified flowchart illustration of an exemplary method of operation of the system of FIG. 1, operative in accordance with an embodiment of the invention. In the method of FIG. 2, information is gathered about software applications configured with a computing device, where the information is itself gathered by a software application that is executed on the computing device (step 200), such as by analyzing data that are associated with the software applications, observing communications between the software applications, and/or by interacting with the software applications and observing responses to such interactions. One or more predefined attack specifications are selected, preferably using any of the information gathered about the software applications (step 202). Any of the selected attack specifications are optionally adapted using any of the information, such as by configuring a test payload for use with a selected attack specification and adapting a selected attack specification and/or its payload using any of the information (step 204). Any of the software applications are then attacked with one or more attacks in accordance with any of the selected attack specifications (step 206). One or more post-attack conditions associated with any of the software applications are identified (step 208). If any of the post-attack conditions is consistent with one or more predefined security vulnerabilities (step 210) one or more predefined actions associated with any identified security vulnerability are performed (step 212).

The system of FIG. 1 and method of FIG. 2 may be illustrated in the context of the following examples:
Application observer 108 determines that software application 102 is configured to receive Android™ intent messages that include a URL, such as “http://foo.bar/”. Application tester 110 selects an attack specification that targets cross-application scripting (XAS) vulnerabilities and configures an associated test payload such that redirects the embedded browser to an HTTP server which is controlled by the attacker, e.g. javascript:document.location.href=‘http://127.0.0.1:1234/<attack_id>’. Application tester 110 then attacks software application 102 using the selected attack and its payload. Security analyzer 112 detects an HTTP access which security analyzer 112 determines is consistent with an XAS vulnerability. Security analyzer 112 then logs or reports the security vulnerability, including the HTTP access information (which acts as a proof for the vulnerability).
Application observer 108 determines that software application 102 is configured to receive Android™ intent messages that include a URL, such as “http://foo.bar/”. Application tester 110 selects an attack specification that that targets XAS vulnerabilities and configures an associated test payload such that it includes a JavaScript™ URI, e.g. javascript:document.location.href=‘http://127.0.0.1:1234/<attack_id>’. Software application 102 is instrumented such that calls to a URL-loading API of a browser embedded within software application 102 are detected by the instrumentation. Application tester 110 then attacks software application 102 using the selected attack and its payload. Security analyzer 112, being in contact with the instrumentation, detects an API call to the embedded browser's URL-loading API, which is consistent with an XAS vulnerability. Security analyzer 112 then reports the finding, preferably including the API parameters and stack trace information indicating the location of the vulnerability within the source code.

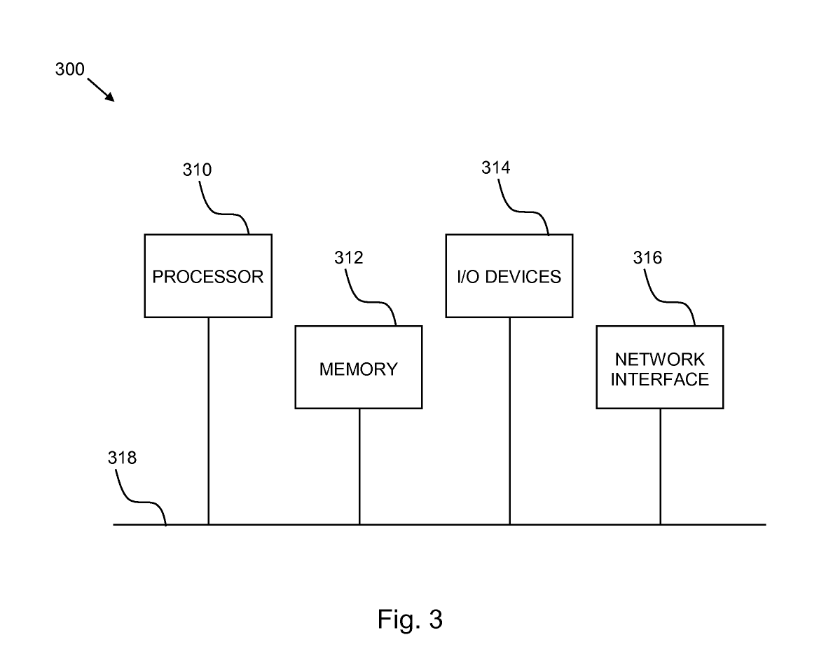

Referring now to FIG. 3, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer.

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for identifying security vulnerabilities on computing devices, the method comprising:
gathering information about a first software application with which a computing device is configured;
selecting, using any of the information, an attack specification from a set of predefined attack specifications;
attacking the first software application on the computing device with an attack that is in accordance with the selected attack specification;
identifying a post-attack condition associated with the first software application;
determining whether the post-attack condition is consistent with a predefined security vulnerability; and
performing a predefined action associated with the predefined security vulnerability responsive to determining that the post-attack condition is consistent with the predefined security vulnerability,
wherein the gathering, selecting, attacking, identifying, determining, and performing are performed by a second software application during execution of the second software application on the computing device.

2. The method of claim 1 wherein the gathering comprises monitoring a communication wherein the first software application is a party to the communication.

3. The method of claim 1 wherein the gathering comprises the second software application interacting with the first software application, wherein the information includes information relating to a response by the first software application to the interaction.

4. The method of claim 1 wherein the gathering comprises the second software application interacting with a third software application with which the computing device is configured, wherein the information includes information relating to a response by the first software application to the interaction.

5. The method of claim 1 wherein the gathering comprises accessing data that is stored on the computing device and that is associated with the first software application.

6. The method of claim 1 wherein the selecting comprises configuring the attack using any of the information.

7. The method of claim 1 wherein the identifying comprises identifying the post-attack condition via instrumentation of the first software application.

8. The method of claim 1 wherein the identifying comprises identifying the post-attack condition by monitoring behavior of the first software application after the attack.

9. The method according to claim 1 wherein the performing step comprises causing a notification to be provided to a user of the computing device describing the security vulnerability.

10. A system comprising:
a processor programmed to initiate executable operations comprising:
gathering information about a first software application with which a computing device is configured;
selecting, using any of the information, an attack specification from a set of predefined attack specifications;
attacking the first software application on the computing device with an attack that is in accordance with the selected attack specification;
identifying a post-attack condition associated with the first software application;
determining whether the post-attack condition is consistent with a predefined security vulnerability; and
performing a predefined action associated with the predefined security vulnerability responsive to determining that the post-attack condition is consistent with the predefined security vulnerability,
wherein the gathering, selecting, attacking, identifying, determining, and performing are performed by a second software application during execution of the second software application on the computing device using the processor.

11. The system of claim 10 wherein the gathering comprises monitoring a communication wherein the first software application is a party to the communication.

12. The system of claim 10 wherein the gathering comprises the second software application interacting with the first software application, wherein the information includes information relating to a response by the first software application to the interaction.

13. The system of claim 10 wherein the gathering comprises the second software application interacting with a third software application with which the computing device is configured, wherein the information includes information relating to a response by the first software application to the interaction.

14. The system of claim 10 wherein the gathering comprises accessing data that is stored on the computing device and that is associated with the first software application.

15. The system of claim 10 wherein the selecting comprises configuring the attack using any of the information.

16. The system of claim 10 wherein the identifying comprises identifying the post-attack condition via instrumentation of the first software application.

17. The system of claim 10 wherein the identifying comprises identifying the post-attack condition by monitoring behavior of the first software application after the attack.

18. The system of claim 10 wherein the performing step comprises causing a notification to be provided to a user of the computing device describing the security vulnerability.

19. A computer program product for identifying security vulnerabilities on computing devices, the computer program product comprising:
a non-transitory, computer-readable storage medium; and
computer-readable program code embodied in the computer-readable storage medium, wherein the computer-readable program code is configured to:
gather information about a first software application with which a computing device is configured,
select, using any of the information, an attack specification from a set of predefined attack specifications,
attack the first software application on the computing device with an attack that is in accordance with the selected attack specification,
identify a post-attack condition associated with the first software application,
determine whether the post-attack condition is consistent with a predefined security vulnerability, and
perform a predefined action associated with the predefined security vulnerability responsive to determining that the post-attack condition is consistent with the predefined security vulnerability,
on the computing device during execution of the computer-readable program code on the computing device.

20. The computer program product of claim 19 wherein the computer-readable program code is configured to monitor a communication wherein the first software application is a party to the communication.
